(19) United States
(12) Patent Application Publication
(10) Pub. No.: US 2021/0168880 A1
(43) Pub. Date: Jun. 3, 2021

(54) USER EQUIPMENT AND COMMUNICATION METHOD

(71) Applicant: NTT DOCOMO, INC., Tokyo (JP)

(72) Inventors: Tomoya Ohara, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 17/268,001

(22) PCT Filed: Aug. 17, 2018
(86) PCT No.: PCT/JP2018/030582

§ 371 Date: Feb. 11, 2021

(51) Int. Cl. H04W 74/08; H04W 56/00; H04W 74/00

(52) U.S. Cl. CPC H04W 74/0833; H04W 74/008; H04W 56/005

(57) ABSTRACT

A user equipment includes a transmission unit that transmits a random access preamble; a reception unit that receives a plurality of random access responses; and a control unit that selects which of the plurality of random access responses received by the reception unit to transmit data.

### TECHNICAL FIELD

The present invention relates to user equipment and communication methods in a radio communication system.

### BACKGROUND ART

The 3GPP (3rd Generation Partnership Project) is studying a wireless communication method called NR (New Radio) or 5G in order to further increase the capacity of the system, further increase the data transmission rate, and further reduce the latency in a radio section. In NR, various wireless technologies are considered in order to meet the requirements of achieving throughput of 10 Gbps or more and reducing the latency of the radio section to 1 ms or less.

NR is assumed to use a wide range of frequencies ranging from a lower frequency band similar to that of LTE to a higher frequency band than that of LTE. In particular, the application of high beam gain beam forming to compensate for the increased propagation loss in the high frequency band has been studied. When transmitting a signal by applying beam forming, it is considered that the base station or the user equipment determines the direction of the transmitting beam so that the receiving quality is good at the communication destination by performing beam sweeping or the like.

As described in Non-Patent Document 1, the Study Item (SI) of the Rel-16 Integrated Access Backhaul (IAB) is currently under discussion in 3GPP.

At the 3GPP RAN1 #92bis meeting in April 2018, it has been agreed that IAB nodes perform the same initial access procedures (including cell search, acquisition of system information (SI) and random access) as the Access UE for connecting to and integrating with other IAB nodes/donors. That is, the IAB node (which may be referred to as a relay base station) performs an initial access procedure (including a random access procedure) for other IAB nodes (which may be referred to as a donor base station) similar to the initial access procedure to be performed when the user equipment connects to the other IAB nodes.

### RELATED ART DOCUMENT

### Non-Patent Document

Non-Patent Document 1: 3GPP TSG RAN Meeting #78, RP-172290, Lisbon, Portugal, Dec. 18-21, 2017
Non-Patent Document 2: 3GPP TS 38.211 V15.2.0 (2018-06)

### SUMMARY OF THE INVENTION

### Problem to be Solved by the Invention

It is assumed that random access procedures similar to the random access procedures in LTE will also be performed in NR. However, the random access procedure between the user equipment and the relay base station or the base station is unclear on the assumption that a radio backhaul link is configured between the relay base station and the base station.

It is necessary to clarify the random access procedure between the user equipment and the relay base station or base station on the assumption that a radio backhaul link is established between the relay base station and the base station.

### Means for Solving the Problem

According to one aspect of the present invention, there is provided user equipment including a transmission unit that transmits a random access preamble; a reception unit that receives a plurality of random access responses; and a control unit that selects which of the plurality of random access responses received by the reception unit is used to transmit data.

### Advantage of the Invention

According to an embodiment of the present invention, a random access procedure between user equipment and a relay base station or base station is defined, provided a radio backhaul link is established between the relay base station and the base station.

### BRIEF DESCRIPTION OF DRAWINGS

FIG. 1 is a diagram illustrating a configuration of a communication system according to an embodiment;

FIG. 2 is a diagram illustrating an example of a random access procedure;

FIG. 3 is a diagram illustrating relationship between the beam and RACH;

FIG. 4 is a diagram illustrating an example of a random access procedure when a radio backhaul link is configured between a relay base station and a donor base station;

FIG. 5 is a diagram illustrating an example of a functional configuration of user equipment 10;

FIG. 6 is a diagram illustrating an example of a functional configuration of a relay base station 20 and a donor base station 30; and

FIG. 7 is a diagram illustrating an example of a hardware configuration of user equipment 10, a relay base station 20, and a donor base station 30.

### EMBODIMENTS OF THE INVENTION

Hereinafter, embodiments of the present invention (the embodiments) are described with reference to the drawings. It should be noted that the embodiments described below are merely an example, and the embodiments to which the present invention is applied are not limited to the following embodiments.

Although the radio communication system in the following embodiments is assumed to be basically NR compliant, this is an example, and the radio communication system in this embodiment may conform, in part or in whole, to a radio communication system other than NR (e.g., LTE).

(Overall System Configuration)

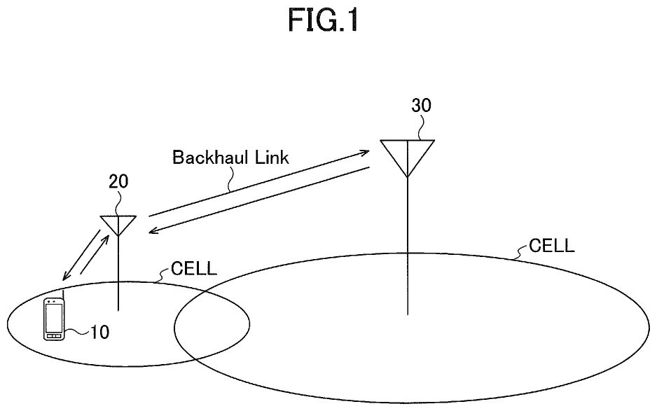

FIG. 1 illustrates a configuration diagram of a radio communication system according to the present embodiment. The radio communication system according to this embodiment includes user equipment 10, a base station 20 (hereinafter referred to as a relay base station), and a base station 30 (hereinafter referred to as a donor base station), as illustrated in FIG. 1. FIG. 1 illustrates one each of the user equipment 10, the relay base station 20, and the donor base station 30, which is an example, and there may be multiple, respectively.

The user equipment 10 is a communication device provided with a radio communication function such as a smartphone, a cellular phone, a tablet, a wearable terminal, a Machine-to-Machine (M2M) communication module, or the like, which wirelessly connects to the relay base station 20 and/or the donor base station 30 and utilizes various communication services provided by the radio communication system. The relay base station 20 is a communication device that provides one or more cells and communicates wirelessly with the user equipment 10. Here, the relay base station 20 may be referred to as an IAB-node. The IAB-node is a wireless access network (RAN) node that has the function of wirelessly connecting the user equipment 10 and backhauling (retransmitting) access traffic from the user equipment 10. The donor base station 30 is a communication device that provides one or more cells and communicates wirelessly with the user equipment 10. The donor base station 30 may be referred to as an IAB-donor. IAB-donor is a RAN node that provides the interface of the user equipment 10 to the core network and provides the wireless backhaul function to the IAB-node. Both the user equipment 10 and the relay base station 20 can perform beam forming to transmit and receive signals. Both the user equipment 10 and the donor base station 30 can perform beam forming to transmit and receive signals. The relay base station 20 may configure a wireless link (also referred to as a wireless backhaul link, wireless relay link, etc.) with the donor base station 30. The relay base station 20 may set up a wireless link with the donor base station 30 and relay communication between the user equipment 10 and the donor base station 30. Here, the relay base station 20 may be provided to extend the coverage of the cells of the donor base station 30. For example, the cell provided by the relay base station 20 and the cell provided by the donor base station 30 may be the same cell, in which case the physical cell ID (PCID) transmitted by the relay base station 20 and the physical cell ID (PCID) provided by the donor base station 30 may be the same. Here, the user equipment 10 may be referred to as UE, the relay base station 20 as a gNB, and the donor base station 30 as a gNB. The relay base station 20 may be referred to as an IAB node and the donor base station 30 may be referred to as an IAB donor.

In this embodiment, the duplex method may be a TDD (Time Division Duplex) method or an FDD (Frequency Division Duplex) method.

Also, in the description of the present embodiment, transmitting a signal using a beam means transmitting a signal in which the precoding vector is multiplied (precoded with a precoding vector). Transmitting a signal using a beam may also be described as transmitting a signal at a particular antenna port. An antenna port is a logical antenna port defined in the 3GPP standard. The method of forming the beam is not limited to the method described above. For example, in user equipment 10 with a plurality of antenna elements and a base station 20 comprising a plurality of antenna elements, a method of changing the angle of each antenna element may be used, a method of combining using a precoding vector and changing the angle of an antenna element may be used, or other methods may be used.

Since the technology according to the present embodiment relates to random access of NR, beam forming, etc., examples of these operations in a radio communication system will be described first.

(Random Access Procedures, etc.)

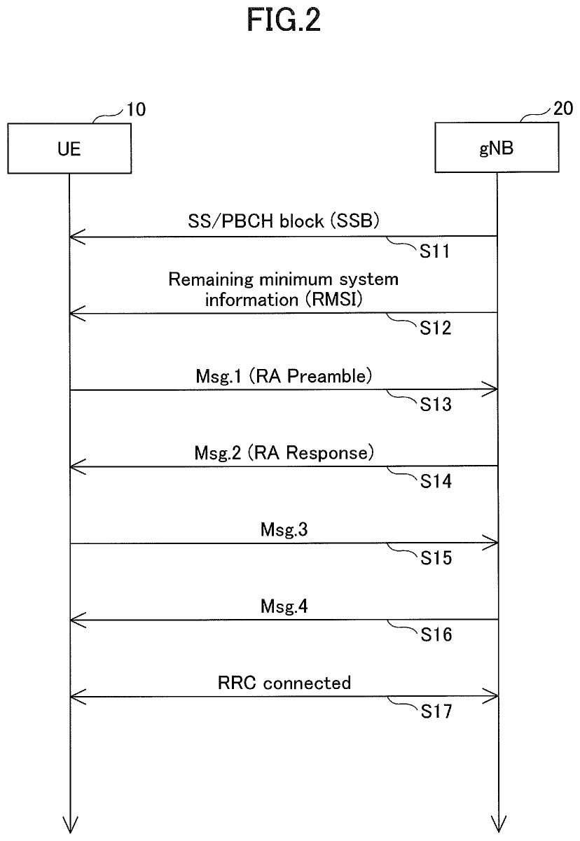

Referring to FIG. 2, an example of a random access procedure in the present embodiment will be described. The procedure illustrated in FIG. 2 may be referred to as initial access.

The base station 20 transmits SS/PBCH block (Synchronization Signal/Physical Broadcast Channel block) (also referred to as SSB (Synchronization Signal Block)) at a predetermined period, and the user equipment 10 receives the SS/PBCH block (S11). The SS/PBCH block includes a synchronization signal, a portion of the system information required for initial access (system frame number (SFN), information necessary to read the remaining system information, etc.). The user equipment 10 also receives an RMSI from the base station 20 (S12). RMSI includes information of SIB1 in, for example, LTE.

Subsequently, the user equipment 10 transmits Message1 (Msg1 (=Random Access(RA) sample) (S13).

When the base station 20 detects the RA preamble, the base station 20 transmits the response Message2 (Msg2 (=RA response)) to the user equipment 10 (S14). In the following description, the term “Msg2” shall include, unless otherwise specified, the PDCCH used for scheduling and the PSDCH carrying the entity information.

The user equipment 10 that receives the RA response transmits a Message3 (Msg3) containing predetermined information to the base station 20 (step S15). Message3 is, for example, an RRC connection request.

The base station 20 that receives Message3 transmits Message4 (Msg4, e.g., RRC connection setup) to the user equipment 10 (S16). When the user equipment 10 verifies that the predetermined information described above is included in the Message 4, the user equipment 10 recognizes that the Message 4 is the Message 4 addressed to the user equipment 10 corresponding to the Message 3 described above, completes the random access procedure, and establishes the RRC connection (S17). FIG. 2 illustrates an example in which Message 3 and Message 4 are transmitted, but this is merely an example. The techniques of this embodiment also applicable to random access procedures where Message 3 and Message 4 are not transmitted.

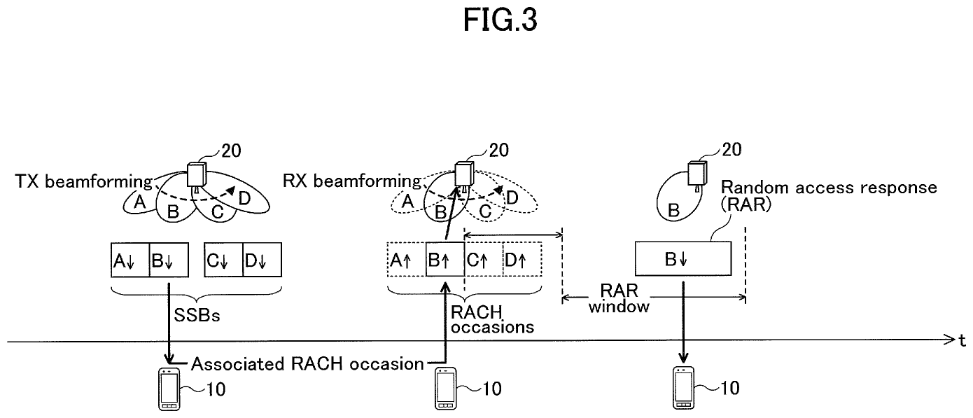

FIG. 3 is a diagram illustrating an example where user equipment 10 selects a beam when a multi-beam operation is performed. In the example of FIG. 3, the base station 20 transmits an SSB with each of the four transmission beams illustrated in A, B, C, and D. For example, SSB-A is transmitted in beam A, SSB-B is transmitted in beam B, SSB-C is transmitted in beam C, and SSB-D is transmitted in beam D.

The user equipment 10 selects an SSB with the highest reception power and/or an SSB with a higher SN ratio, for example, and transmits a RA preamble with the resource B associated with the index of the SSB. The resource for sending RA preamble may be referred to as RACH occasion. Thereafter, for example, the base station 20 understands that the transmission beam B has been selected as the transmission beam to the user equipment 10 by receiving the RA preamble at the resource B, and transmits the RA response, for example, using the transmission beam B. The relationship between the SSB (beam) and the RACH occasion is notified to the user equipment 10 in advance.

The NR synchronization signal consists of two signals: a primary synchronization signal (PSS) and a secondary synchronization signal (SSS). The user equipment 10 acquires a cell ID index by detecting a primary synchronization signal and acquires a cell ID group index by detecting a secondary synchronization signal. Thereafter, the user equipment 10 can calculate the physical cell ID (PCID) using the acquired cell ID index and the cell ID group index. The physical cell ID is the identifier of physical cells; 504 IDs are used in the LTE, and 1008 IDs are used in the NR.

(About Random Access of IAB Nodes)

As an agreement at the 3GPP meeting, the IAB node (which may be referred to as a relay base station) may perform an initial access procedure (including random access procedure) for other IAB nodes (which may be referred to as a donor base station) similar to the initial access procedure (including random access procedure) to be performed when the user equipment connects to the other IAB nodes. For example, in setting a radio backhaul link between the relay base station 20 illustrated in FIG. 1 and the donor base station 30, the relay base station 20 may perform the above described random access procedure with reference to FIGS. 2 and 3 between the donor base station 30. In this case, the relay base station 20 performs the same procedure as the user equipment 10, and the donor base station 30 may perform the same procedure as the base station 20.

(Problems)

In the system configuration illustrated in FIG. 1, it is assumed that the relay base station 20 and the donor base station 30 have a common physical cell ID. That is, it is assumed that the physical cell ID detected from the synchronization signal transmitted by the relay base station 20 and the physical cell ID detected from the synchronization signal transmitted by the donor base station 30 are the same. User equipment 10 (or an IAB node other than the relay base station 20 and the donor base station 30) that intends to connect to the relay base station 20 or the donor base station 30 receives an SS/PBCH block. In this case, since the physical cell ID of the relay base station 20 and the physical cell ID of the donor base station 30 are the same, to the user equipment 10 cannot determine whether the received SS/PBCH block is an SS/PBCH block transmitted from the relay base station 20 or an SS/PBCH block transmitted from the donor base station 30. It is necessary to clarify the random access procedure in this case.

Hereinafter, a random access procedure in a system comprising user equipment 10, a relay base station 20, and a donor base station 30, as illustrated in FIG. 1, is described as an example. However, the configuration of the system is not limited to the configuration illustrated in FIG. 1. That is, the random access procedure described below may be applied to any combination of a parent node and a child node (donor/IAB node, access UE) (which may be referred to as a single hop), or more than three nodes (which may be referred to as a multi-hop). Here, the case of three or more nodes may include, for example, the case of a parent node, a child node, and a grandchild node, the case of two parent nodes and one child node, or the case of one parent node and two child nodes. In particular, the user equipment 10 may be an IAB node.

(Transmission of Msg1 after the Detection of SS/PBCH Block)

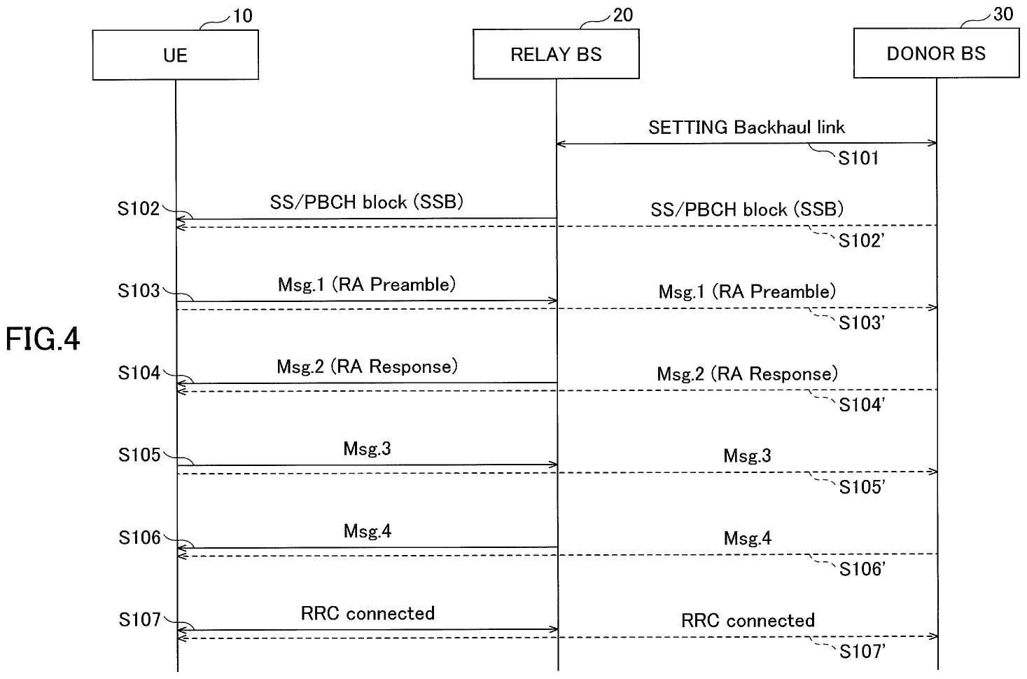

Hereinafter, some examples of random access procedures are described with reference to FIG. 4. In step S101, the relay base station 20 sets a radio backhaul link with the donor base station 30.

The user equipment 10 that receives the SS/PBCH block transmitted from the relay base station 20 in step S102 and the SS/PBCH block transmitted from the donor base station 30 in step S102′ may transmit Message1 (Msg1(=Random Access(RA) sample) without distinguishing whether the received SS/PBCH block is an SS/PBCH block transmitted from the relay base station 20 or an SS/PBCH block transmitted from the donor base station 30. For example, the user equipment 10 may select an SS/PBCH block with the highest reception power and/or a high SN ratio (identifying the index of the SS/PBCH block with the highest reception power and/or the high SN ratio, and/or the index of the SS/PBCH block with the high SN ratio), and transmit the RA preamble with the resource associated with the index of the SS/PBCH block, without distinguishing whether the received SS/PBCH block is an SS/PBCH block transmitted from the relay base station 20 or an SS/PBCH block transmitted from the donor base station 30. In this case, the transmission resource for transmitting the RA preamble, the transmission power for transmitting the RA preamble, the transmitting beam for transmitting the RA preamble, and the like may be defined based on the selected SS/PBCH block. In this case, for the index of the same SS/PBCH block, there may actually be different SS/PBCH blocks (SS/PBCH blocks transmitted from the relay base station 20 and SS/PBCH blocks transmitted from the donor base station 30). If multiple SS/PBCH blocks exist for the same SS/PBCH block index, different SS/PBCH blocks may be used to determine the transmission resource to send RA preambles, the transmission power to transmit RA preambles, and the transmission beam to transmit RA preambles. Alternatively, only SS/PBCH blocks received at a certain time (e.g., SS/PBCH blocks received at the earliest time) among multiple SS/PBCH blocks may be used to determine the transmission resource to transmit RA preambles, the transmission power to transmit RA preambles, and the transmission beam to transmit RA preambles.

(Transmission of Msg2)

As illustrated in steps S103 and S103′ of FIG. 4, RA preambles transmitted from the user equipment 10 may be received at both the relay base station 20 and the donor base station 30. Accordingly, it is necessary to clarify how the relay base station 20 and the donor base station 30 transmit Msg2 in response to receiving the RA preamble. Here, when only one node of the relay base station 20 and the donor base station 30 receives a RA preamble, if there is no communication between the relay base station 20 and the donor base station 30 regarding the reception of the RA preamble, one node of the relay base station 20 and the donor base station 30 cannot know whether or not the other node of the relay base station 30 receives the RA preamble.

Hereinafter, as illustrated in FIG. 4, a method of transmitting Msg2 when a radio backhaul link is set between the relay base station 20 and the donor base station 30, that is, when the relay base station 20 and the donor base station 30 are connected (for example, it may be referred to as a connected mode) is described.

### First Example

In the first example, the relay base station 20 and the donor base station 30 exchange information on the reception of the RA preamble, and after determining which will transmit the Msg2, transmit the Msg2. Examples of information exchanged between the relay base station 20 and the donor base station 30 include information on whether or not the RA preamble has been received, information identifying the received RA preamble (e.g., preamble ID or Random Access-Radio Network Temporary Identifier (RA-RNTI) based on the locations of received resources), Timing Advance (TA) value (may be any of the TA value between the donor base station 30 and the user equipment 10, the TA value between the donor base station 30 and the relay base station 20, or the TA value between the relay base station 20 and the user equipment 10), and the reception strength and reception quality of the RA preamble. In the first example, based on the information described above, it is determined which node of the relay base station 20 and the donor base station 30 is appropriate to transmit Msg2, and based on the determination result, one node of the relay base station 20 and the donor base station 30 is selected and Msg2 is transmitted from the selected node. Here, the determination of which node of the relay base station 20 and the donor base station 30 is suitable for transmitting Msg2 may be performed at the donor base station 30 or at the relay base station 20. For example, if the TA value is exchanged between the relay base station 20 and the donor base station 30, the TA value between the donor base station 30 and the user equipment 10 may be compared with the TA value between the relay base station 20 and the user equipment 10, and the node with the lower TA value may be selected as the node transmitting Msg2. By comparing the TA values, it is possible to estimate whether the user equipment 10 is located closer to the relay base station 20 or closer to the donor base station 30.

In the case of a multi-hop relay, a limit may be set to the range in which information is conveyed, such as exchanging information only between adjacent nodes. When a node communicates information with a first neighboring node, the node may select particular information to notify the first node in information obtained by combining the information obtained from the second neighboring node with the information obtained by the node itself. For example, the node may compare the TA value obtained from the second neighboring node with the TA value measured by the node itself and notify the first neighboring node of the lower TA value. The first example described above is not limited to the example of comparing the TA value between the donor base station 30 and the user equipment 10 with the TA value between the relay base station 20 and the user equipment 10 to select a node with a lower TA value as the node to transmit Msg2. For example, a node that has measured a TA value that is determined to be optimal by some criterion among the multiple TA values obtained by measuring at multiple nodes may be selected as a node that transmits Msg2.

### Second Example

In the second example, when the donor base station 30 receives a RA preamble from the relay base station 20 and the donor base station 30, the donor base station 30 preferentially transmits Msg2. In this case, for example, information on whether or not the RA preamble has been received and information identifying the received RA preamble may be exchanged between the relay base station 20 and the donor base station 30. If it is determined that the relay base station 20 and the donor base station 30 have received the same RA preamble, the donor base station 30 may transmit Msg2 and the relay base station 20 may not transmit Msg2. In addition, if the relay base station 20 receives a RA preamble, but the donor base station 30 does not receive a RA preamble, the relay base station 20 may transmit an Msg2. As another example, the donor base station 30 may immediately transmit Msg2 in response to receiving RA preambles. In the second example, a random access procedure can be performed with fewer hops (2 hops when the user equipment 10 is connected to the relay base station 20, but 1 hop when the user equipment 10 is connected to the donor base station 30). As a second variation, if the relay base station 20 is provided at the edge of the cell of the donor base station 30 and the user equipment 10 performs a random access procedure at the edge of the cell, the reception level at the donor base station 30 of the signal transmitted from the user equipment 10 is considered to be low. Therefore, if the relay base station 20 from the relay base station 20 and the donor base station 30 receives the RA preamble, the relay base station 20 may preferentially transmit the Msg2. In this case, a comparison of the TA values can be used to estimate that the user equipment 10 is performing a random access procedure at the cell edge.

### Third Example

In the third example, among the relay base station 20 and the donor base station 30, a node that has previously received the RA preamble transmits Msg2. In this case, for example, information on whether or not the RA preamble has been received and information identifying the received RA preamble may be exchanged between the relay base station 20 and the donor base station 30. In addition, for example, among the relay base station 20 and the donor base station 30, the node that received the RA preamble first notifies the other node that the RA preamble has been received, so that the other node does not transmit the Msg2. According to a third example, in a random access procedure, the process can be transferred to the transmission procedure of Msg2 as soon as possible.

### Fourth Example

In the fourth example, both the relay base station 20 and the donor base station 30 receive RA preambles and both the relay base station 20 and the donor base station 30 transmit Msg2. In this case, after receiving the first Msg2 at the user equipment 10, Flag information indicating whether or not the user equipment 10 will continue to receive (search) Msg2 may be notified to the user equipment 10. The Flag information may be included in the Msg2 or may be previously notified by notification, signaling, or the like from the relay base station 20 or the donor base station 30.

When both the relay base station 20 and the donor base station 30 as described above transmit Msg2, the user equipment 10 (which may be an IAB node) may use previously received Msg2 with respect to time to perform subsequent transmission (transmission of Msg3 or uplink data communication via Physical Uplink Shared Channel (PUSCH)).

In the case where both the relay base station 20 and the donor base station 30 transmit Msg2, the user equipment 10 may alternatively determine the content of Msg2, select the Msg2 to be used, and perform subsequent transmission (transmission of Msg3 or uplink data communication via PUSCH) using the selected Msg2. Here, the user equipment 10 may use the TA value or UL grant information included in the Msg2 as information used to determine which Msg2 is used among the received Msg2. For example, the user equipment 10 may compare the TA value to determine that Msg2 containing a smaller TA value is used. The user equipment 10 may also compare the UL grant information to determine that Msg2 including earlier timing scheduling information is used in the time direction. Additionally or alternatively, the user equipment 10 may compare the UL grant information to determine that it uses Msg2 containing UL grant information with a smaller amount of resources allocated in the frequency direction, in which case the user equipment 10 may transmit uplink data farther. Alternatively, Msg2 may include information indicating the priority of Msg2 transmitted from the relay base station 20 and Msg2 transmitted from the donor base station 30, and in this case, the user equipment 10 may determine the Msg2 to be used in accordance with the information indicating the priority included in Msg2.

In the case where both the relay base station 20 and the donor base station 30 transmit Msg2, the user equipment 10 may alternatively select one of Msg2 to be used from the received Msg2 based on the reception power (e.g., RSRP), the reception quality (e.g., RSRQ), etc. of the Msg2, and perform subsequent transmission (transmission of Msg3 or uplink data communication via PUSCH) using the selected Msg2. In selecting the Msg2 to be used, the judgment criteria such as whether reception power is used or reception quality is used may be notified to the user equipment 10 in advance or may be specified in the specification or the like. In addition, in the case where Msg2 is transmitted multiple times from the relay base station 20 or the donor base station 30, the user equipment may be notified in advance of the measurement method such as the reception quality, such as whether the reception power, the reception quality, or the like is measured using a single Msg2 or whether the reception power, the reception quality, or the like is measured by combining the Msg2 received multiple times.

Alternatively, when both the relay base station 20 and the donor base station 30 transmit Msg2, the user equipment 10 may use Msg2 received from the relay base station 20 in response to receiving Msg2 from both the relay base station 20 and the donor base station 30 to conduct subsequent transmission (transmission of Msg3 or uplink data communication via PUSCH) and use Msg2 received from the donor base station 30 to perform subsequent transmission (transmission of Msg3 or uplink data communication via PUSCH).

### Other Examples

In the example illustrated in FIG. 4, it is assumed that a radio backhaul link is set between the relay base station 20 and the donor base station 30. However, it is also contemplated that the wireless backhaul link between the relay base station 20 and the donor base station 30 may be disconnected. In this case, a random access procedure may be performed from the relay base station 20 to the donor base station 30. In this case, the random access procedure described with reference to FIG. 4 above can be applied as a random access procedure.

In the situation where the wireless backhaul link between the relay base station 20 and the donor base station 30 is not connected, for example, when the user equipment 10 transmits a RA preamble to the relay base station 20, and when the Msg2 is not transmitted from the donor base station 30 to the user equipment 10 (e.g., when the RA preamble does not reach the donor base station 30), the relay base station 20 may perform a random access procedure with the user equipment 10 after setting up a wireless backhaul link between the donor base station 30. Alternatively, when the wireless backhaul link between the relay base station 20 and the donor base station 30 is not connected, e.g., the user equipment 10 transmits RA preamble to the relay base station 20, and the donor base station 30 does not transmit Msg2 to the user equipment 10, the relay base station 20 may perform a random access procedure with the user equipment 10 while performing a random access procedure to set up a wireless backhaul link between the donor base station 30 in parallel.

In addition, when the radio backhaul link between the relay base station 20 and the donor base station 30 is not connected, for example, when the relay base station 20 receives a RA preamble, the relay base station 20 may perform a random access procedure with the user equipment 10 after setting a radio backhaul link with the donor base station 30. Alternatively, if the wireless backhaul link between the relay base station 20 and the donor base station 30 is not connected, when the relay base station 20 receives a RA readable, the relay base station 20 may perform a random access procedure with the user equipment 10 while performing a random access procedure to set up a wireless backhaul link with the donor base station 30.

(Device Configuration)

Next, a functional configuration example of user equipment 10, a relay base station 20, and a donor base station 30 that executes the process operation described above is described. The user equipment 10, the relay base station 20, and the donor base station 30 have all of the functions described in this embodiment. However, the user equipment 10, the relay base station 20, and the donor base station 30 may include only some of the functions described in this embodiment. The user equipment 10, the relay base station 20, and the donor base station 30 may be collectively referred to as a communication device.

<User Equipment>

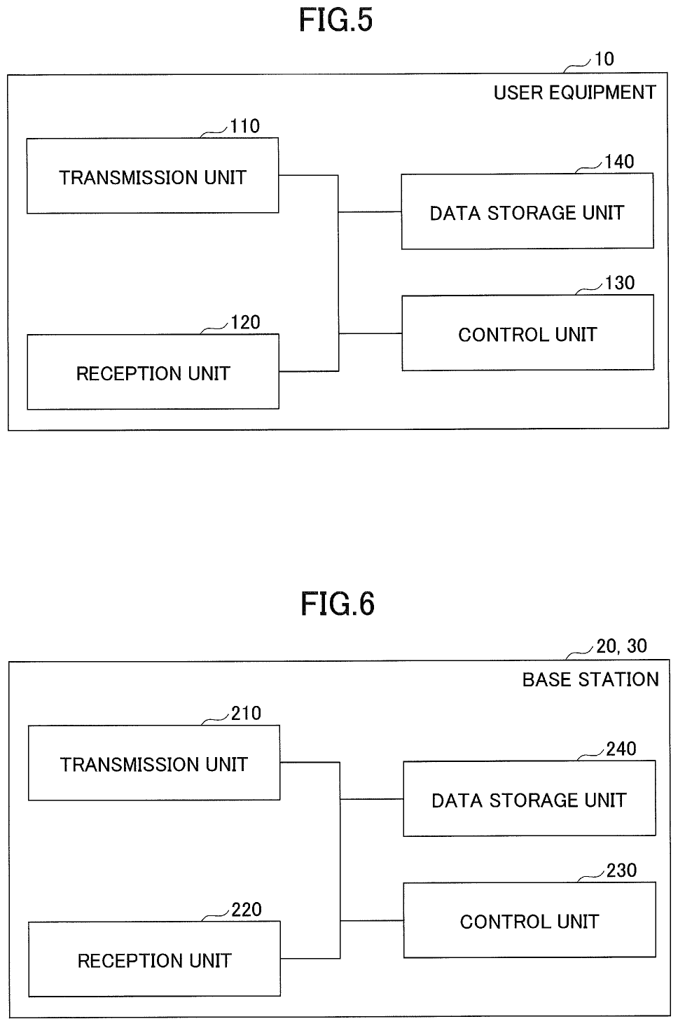

FIG. 5 is a diagram illustrating an example of a functional configuration of user equipment 10. As illustrated in FIG. 5, the user equipment 10 includes a transmission unit 110, a reception unit 120, a control unit 130, and a data storage unit 140. The functional configuration illustrated in FIG. 5 is merely an example. If the operation according to the present embodiment can be executed, the functional classification and the name of the functional portion may be arbitrary. The transmission unit 110 may be referred to as a transmitter, and the reception unit 120 may be referred to as a receiver.

The transmission unit 110 generates a transmission signal from the transmission data and transmits the transmission signal wirelessly. The transmission unit 110 may form one or more beams. The reception unit 120 receives a variety of signals wirelessly and acquires a higher layer signal from the received physical layer signal. The reception unit 120 includes a measuring unit that performs measurement of the received signal and acquires the reception power, etc.

The control unit 130 controls the user equipment 10. The function of the control unit 130 related to the transmission may be included in the transmission unit 110, and the function of the control unit 130 related to the reception may be included in the reception unit 120. For example, the setting information is stored in the data storage unit 140. The setting information related to transmission may be stored in the transmission unit 110, and the setting information related to reception may be stored in the reception unit 120.

For example, the reception unit 120 may be configured to receive an SS/PBCH block transmitted from the relay base station 20 and the donor base station 30, and the control unit 130 may be configured to determine the position of the transmission resource of the message 1 based on the index of the SS/PBCH block. The transmission unit 110 is configured to transmit the message 1 using the position of the transmission resource of the determined message 1 under the control of the control unit 130.

For example, the control unit 130 may be configured to select, for example, an SS/PBCH block with the highest reception power and/or an SS/PBCH block with a highest SN ratio (and identifying the index of the SS/PBCH block with the highest reception power and/or the index of the SS/PBCH block with the highest SN ratio) without distinguishing whether the received SS/PBCH block is an SS/PBCH block transmitted from the relay base station 20 or an SS/PBCH block transmitted from the donor base station 30, and determine the location of the transmission resource associated with the index of the SS/PBCH block as the location of the transmission resource transmitting the RA preamble.

For example, if there are multiple different SS/PBCH blocks with respect to the same index of SS/PBCH blocks, the control unit 130 may determine the transmission resource for transmitting the RA preamble, the transmission power for transmitting the RA preamble, and the transmission beam for transmitting the RA preamble, using all of the multiple different SS/PBCH blocks. Alternatively, the control unit 130 may determine the transmission resource to transmit the RA preamble, the transmission power to transmit the RA preamble, and the transmission beam to transmit the RA preamble, using only the SS/PBCH blocks received at a certain time (e.g., the SS/PBCH blocks received at the earliest timing) among the plurality of SS/PBCH blocks.

For example, the reception unit 120 may receive Msg2 from both the relay base station 20 and the donor base station 30. In this case, for example, the control unit 130 may determine that the Msg2 previously received with respect to time is used for subsequent transmission (transmission of Msg3 or uplink data communication via Physical Uplink Shared Channel (PUSCH)).

Alternatively, the control unit 130 may determine the content of the Msg2 and select the Msg2 to be used for subsequent transmission. Here, the control unit 130 may use UL grant information or the TA value included in the Msg2 as information used to determine which Msg2 is used among the received Msg2. For example, the control unit 130 may compare the TA values to determine that Msg2 containing a smaller TA value is used. In addition, the control unit 130 may compare the UL grant information to determine that Msg2 containing the scheduling information at an earlier time is used in time direction. Additionally or alternatively, the control unit 130 may compare UL grant information to determine that Msg2 containing UL grant information with a smaller size of resources assigned in frequency direction is used. Alternatively, Msg2 may include information indicating a priority order as to which Msg2 is to be prioritized, the Msg2 transmitted from the relay base station 20 or Msg2 transmitted from the donor base station 30. In this case, the control unit 130 may determine the Msg2 to be used in accordance with the information indicating the priority order included in the Msg2.

Alternatively, the control unit 130 may select which Msg2 of the received Msg2 is used based on the reception power of the Msg2 (e.g., RSRP), the reception quality (e.g., RSRQ), etc.

Alternatively, the control unit 130 may determine that, in response to the reception unit 120 receiving Msg2 from both the relay base station 20 and the donor base station 30, Msg2 received from the relay base station 20 is used for subsequent transmission, and Msg2 received from the donor base station 30 is used for subsequent transmission.

<Relay Base Station 20, Donor Base Station 30>

FIG. 6 is a diagram illustrating an example of a functional configuration of a relay base station 20 and a donor base station 30. As illustrated in FIG. 6, the relay base station 20 and the donor base station 30 have a transmission unit 210, a reception unit 220, a control unit 230, and a data storage unit 240, respectively. The functional configuration illustrated in FIG. 6 is merely an example. The functional classification and the name of the functional portion may be any one as long as the operation according to the present embodiment can be executed. The transmission unit 210 may be referred to as a transmitter, and the reception unit 220 may be referred to as a receiver.

The transmission unit 210 includes a function of generating a signal to be transmitted to the user equipment 10 and transmitting the signal wirelessly. The transmission unit 210 also forms one or more beams. The reception unit 220 includes a function for receiving various signals transmitted from the user equipment 10 and acquiring information of a higher layer, for example, from the received signal. The reception unit 220 includes a measuring unit that performs measurement of the received signal and acquires the reception power, etc.

The control unit 230 controls the base station 20. The function of the control unit 230 related to the transmission may be included in the transmission unit 210, and the function of the control unit 230 related to the reception may be included in the reception unit 220. For example, the setting information is stored in the data storage unit 240. The setting information related to the transmission may be stored in the transmission unit 210, and the setting information related to the reception may be stored in the reception unit 220.

For example, the transmission unit 210 and the reception unit 220 of the relay base station 20 may be configured to perform radio backhaul link communication with the transmission unit 210 and the reception unit 220 of the donor base station 30.

For example, the transmission unit 210 and the reception unit 220 of the relay base station 20 exchange information on the reception of the RA preamble with the transmission unit 210 and the reception unit 220 of the donor base station 30, and the control unit 230 of the relay base station 20 or the donor base station 30 may determine which is to transmit the Msg2.

For example, when the transmission unit 210 and the reception unit 220 of the relay base station 20 exchange the TA value with the transmission unit 210 and the reception unit 220 of the donor base station 30, the control unit 230 of the relay base station 20 or the donor base station 30 may compare the TA value between the donor base station 30 and the user equipment 10 to the TA value between the relay base station 20 and the user equipment 10, and select the node with the lower TA value as the node transmitting the Msg2.

For example, the control unit 230 of the relay base station 20 and the control unit 230 of the donor base station 30 may be configured, when the reception unit 220 of the relay base station 20 and the reception unit 220 of the donor base station 30 receive RA preambles, to determine that the donor base station preferentially transmits Msg2.

For example, the control unit 230 of the relay base station 20 and the control unit 230 of the donor base station 30 may be configured to determine that a node that has previously received the RA preamble transmits Msg2.

For example, when both the relay base station 20 and the donor base station 30 receive RA preambles, the control unit 230 of the relay base station 20 and the control unit 230 of the donor base station 30 may be configured to determine that both the relay base station 20 and the donor base station 30 transmit Msg2. In this case, the control unit 230 of the relay base station 20 and the control unit 230 of the donor base station 30 may be configured to include Flag information indicating whether or not the user equipment 10 continues to receive (search) Msg2 after receiving the first Msg2 at the user equipment 10.

<Hardware Configuration>

The block diagram (FIGS. 5 to 6) used in the description of the above-described embodiment illustrates blocks function by function. These functional blocks (components) are implemented by any combination of hardware and/or software. Further, the means for implementing each functional block is not particularly limited. That is, each functional block may be implemented by multiple elements physically and/or logically combined as a single device, or may be implemented by two or more devices that are physically and/or logically separated but directly and/or indirectly (e.g., wired and/or wireless) connected.

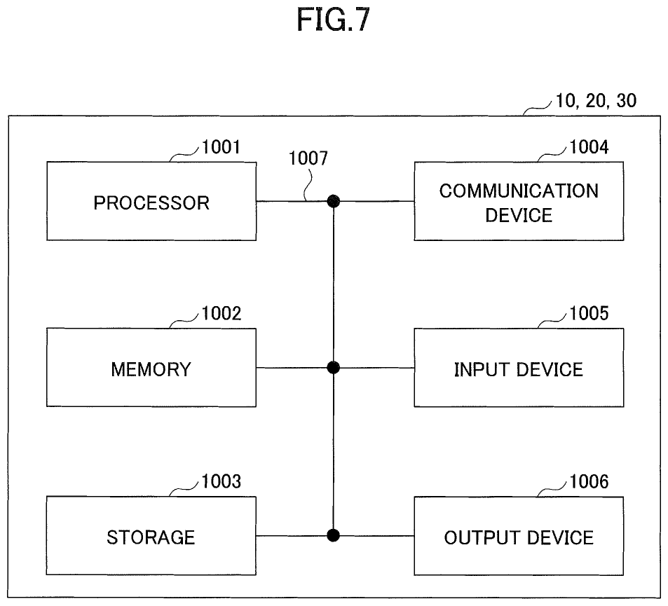

For example, the user equipment 10, the relay base station 20, and the donor base station 30 according to one embodiment of the present invention may function as a computer performing processing according to the present embodiment. FIG. 7 is a diagram illustrating an example of a hardware configuration of user equipment 10, a relay base station 20, and a donor base station 30 according to the present embodiment. The user equipment 10, the relay base station 20, and the donor base station 30 described above may each be physically configured as a computer device including a processor 1001, a memory 1002, a storage 1003, a communication device 1004, an input device 1005, an output device 1006, a bus 1007, and the like.

In the following description, the term “device” can be interpreted as a circuit, device, unit, etc. The hardware configuration of the user equipment 10, the relay base station 20, and the donor base station 30 may be configured to include one or more of the devices illustrated in the figure designated as 1001-1006, or may be configured without some devices.

Each function in the user equipment 10, the relay base station 20, and the donor base station 30 is realized by having the processor 1001 reads a predetermined software (program) on hardware, such as the processor 1001, the memory 1002, so that the processor 1001 performs mathematical and/or logical operations and controls the communication by the communication device 1004, the reading and/or writing of data in the memory 1002 and the storage 1003.

Processor 1001, for example, operates an operating system to control the entire computer. Processor 1001 may be comprised of a central processing unit (CPU) including interfaces with peripheral devices, control devices, computing devices, registers, and the like.

Processor 1001 also reads programs (program code), software modules or data from storage 1003 and/or communication device 1004 into memory 1002 and performs various processing in accordance therewith. As a program, a program that causes a computer to execute at least a portion of the operation described in the above-described embodiment is used. For example, the transmission unit 110, the reception unit 120, the control unit 130, and the data storage unit 140 of the user equipment 10 illustrated in FIG. 5 may be implemented by a control program stored in the memory 1002 and run on the processor 1001. For example, the transmission unit 210, the reception unit 220, the control unit 230, and the data storage unit 240 of the relay base station 20 illustrated in FIG. 6 and the donor base station 30, respectively, may be implemented by a control program stored in the memory 1002 and run on the processor 1001. While the various processes described above have been described as being executed in one processor 1001, they may be executed simultaneously or sequentially by two or more processors 1001. Processor 1001 may be implemented in one or more chips. The program may be transmitted from the network via a telecommunications line.

Memory 1002 is a computer readable storage medium, and may be comprised of at least one such as, for example, ROM (Read Only Memory), EPROM (Erasable Programmable ROM), EEPROM (Electrically Erasable Programmable ROM), RAM (Random Access Memory). Memory 1002 may be referred to as a register, cache, main memory (main storage device), or the like. Memory 1002 may store programs (program code), software modules, etc. executable for executing processing according to one embodiment of the present invention.

Storage 1003 is a computer readable storage medium and may be comprised of, for example, at least one of an optical disk, such as a CD-ROM (Compact Disc ROM), a hard disk drive, a flexible disk, an optical magnetic disk (e.g., a compact disk, a digital versatile disk, a Blu-ray™ disk, a smart card, a flash memory (e.g., a card, a stick, a key drive), a Floppy™ disk, a magnetic strip, or the like. Storage 1003 may be referred to as an auxiliary storage device. The storage medium described above may be, for example, a database including memory 1002 and/or storage 1003, a server, or other suitable medium.

Communication device 1004 is a hardware (transceiver device) for communicating between computers over a wired and/or wireless network, and is also referred to, for example, as a network device, a network control unit, a network card, a communication module, and the like. For example, the transmission unit 110 and the reception unit 120 of the user equipment 10 may be implemented in the communication device 1004. The transmission unit 210 and the reception unit 220 of the relay base station 20 and the donor base station 30, respectively, may be implemented in the communication device 1004.

The input device 1005 is an input device (e.g., a keyboard, a mouse, a microphone, a switch, a button, a sensor, etc.) that receives input from an external entity. The output device 1006 is an output device (e.g., a display, speaker, LED lamp, etc.) that sends output to an external entity. The input device 1005 and the output device 1006 may be of an integrated configuration (e.g., a touch panel).

Each device, such as processor 1001 and memory 1002, is also connected by a bus 1007 for communicating information. The bus 1007 may be comprised of a single bus or may be comprised of different buses between devices.

Also, the user equipment 10, the relay base station 20, and the donor base station 30 may each include hardware such as a microprocessor, a digital signal processor (DSP), an ASIC (Application Specified Circuit), a PLD (Programmable Logic Device), and a FPGA (Field Programmable Gate Array), which may implement some or all of the functional blocks. For example, processor 1001 may be implemented in at least one of these hardware.

### Conclusion of the Embodiments

As described above, according to the embodiments, there is provided user equipment including a transmission unit that transmits a random access preamble; a reception unit that receives a plurality of random access responses; and a control unit that selects which of the plurality of random access responses received by the reception unit is used to transmit data.

In this manner, when the same cell ID is assigned to the relay base station and the donor base station, and the SS/PBCH block transmitted from the relay base station 20 and the SS/PBCH block transmitted from the donor base station 30 cannot be distinguished, the random access preamble transmitted from the user equipment may be received by both the relay base station and the donor base station, in which case the relay base station may transmit a random access response and the donor base station may transmit a random access response. In this way, when a plurality of random access responses is received, the control unit of the user equipment can determine which of a plurality of random access responses is used to transmit data, thereby clarifying the random access procedure when a backhaul link is set between the relay base station and the donor base station.

The control unit of the user equipment may select the first random access response received with respect to time among the plurality of random access responses received by the reception unit. This reduces the time required to perform a random access procedure when a backhaul link is set between the relay base station and the donor base station.

The control unit of the user equipment may compare the timing advance value included in each random access response of the plurality of random access responses received by the reception unit to detect the minimum timing advance value and select a random access response including the minimum timing advance value. By using a random access response transmitted from a node with a minimum timing advance value to determine that data is to be transmitted, the user equipment can be connected to a node located closer to the user equipment.

The control unit of the user equipment may compare the scheduling information included in each random access response of the plurality of random access responses received by the reception unit to detect scheduling information including the earliest uplink transmission timing with respect to time and select a random access response including scheduling information including the earliest uplink transmission timing. This reduces the delay in data transmission by random access procedures.

The control unit of the user equipment may compare the scheduling information included in each random access response of the plurality of random access responses received by the reception unit to detect scheduling information including allocation information of a resource having the smallest frequency-direction size, and select a random access response including scheduling information including allocation information of a resource having the smallest frequency-direction size. In this case, due to the large frequency direction size, it is possible to suppress the decrease in the transmission power for transmitting the data, and the user equipment is able to transmit the uplink data more distantly.

According to the embodiments, there is also provided a communication method including the steps of transmitting a random access preamble, receiving a plurality of random access responses, and selecting which of the received plurality of random access responses is used to transmit data. According to this communication method, when a plurality of random access responses is received, one of a plurality of random access responses can be used to determine which of the data is transmitted, thereby clarifying the random access procedure when a backhaul link is set between the relay base station and the donor base station.

### Supplemental Embodiment

While the embodiments of the present invention are described above, the disclosed invention is not limited to such embodiments, and those skilled in the art will understand various modifications, modifications, alternatives, substitutions, and the like. Descriptions have been made using specific numerical examples to facilitate understanding of the invention, but, unless otherwise indicated, these values are merely examples and any suitable value may be used. Classification of the items in the above description is not essential to the present invention, and the items described in two or more items may be used in combination as needed, or the items described in one item may be applied (unless inconsistent) to the items described in another item. The boundaries of functional parts or processing parts in the functional block diagram do not necessarily correspond to the boundaries of physical parts. The operation of the plurality of functional portions may be physically performed on one part or the operation of one functional portion may be physically performed on more than one part. For the processing procedures described in the embodiment, the order of processing may be changed as long as there is no inconsistency. For the convenience of the process description, the user equipment 10 and the base station 20 have been described using functional block diagrams, but such devices may be implemented in hardware, software, or a combination thereof. Software operated by a processor of the user equipment 10 in accordance with embodiments of the present invention and software operated by a processor of the base station 20 in accordance with embodiments of the present invention may be stored in random access memory (RAM), flash memory (RAM), read-only memory (ROM), EPROM, EEPROM, registers, hard disks (HDD), removable disks, CD-ROM, databases, servers, or any other suitable storage medium, respectively.

In the above example, a method has been proposed of identifying a time frequency resource location based on the SSB index and the corresponding RACH Occasion index for transmitting random access preambles when the location of the time frequency resource could not be determined with the SSB index and the corresponding RACH Occasion index alone. However, the method described above can be applied in the same way, considering the time position of the resource, even in cases where the sample index is divided into SSBs (cases where multiple SSBs are tied to a single RACH occasion).

It is also applicable to contention free random access other than PDCCH order, such as handover or the addition of PSCell.

In addition, it is applicable to CSI-RS based random access rather than SS block.

Notification of information is not limited to the embodiments/embodiments described herein, but may be performed in other ways. For example, the notification of information may be implemented by physical layer signaling (e.g., DCI (Downlink Control Information), UCI (Uplink Control Information), upper layer signaling (e.g., RRC (Radio Resource Control) signaling, MAC (Medium Access Control) signaling, broadcast information (MIB (Master Information Block), SIB (System Information Block), or other signals or combinations thereof. RRC signaling may be referred to as an RRC message, for example, and may be an RRC Connection Setup message, an RRC Connection Reconfiguration, or the like.

The embodiments/embodiments described herein may be applied to systems utilizing LTE (Long Term Evolution), LTE-A (LTE-Advanced), SUPER 3G, IMT-Advanced, 4G, 5G, FRA (Future Radio Access), W-CDMA (Registered Trademark), GSM (Registered Trademark), CDMA2000, UMB (Ultra Mobile Broadband), IEEE 802.11 (Wi-Fi), IEEE 802.16 (WiMAX), IEEE 802.20, UWB (Ultra-Wide Band), Bluetooth (Registered Trademark), and/or other suitable systems and/or extended thereon.

The processing procedures, sequences, flow charts, etc. of each aspect/embodiment described herein may be reordered, unless otherwise inconsistent. For example, the methods described herein present elements of various steps in an exemplary order and are not limited to the particular order presented.

The particular operation described herein to be performed by base station 20 may be performed by an upper node in some cases. It is apparent that in a network consisting of one or more network nodes having base stations 20, various operations performed for communicating with user equipment 10 may be performed by base stations 20 and/or other network nodes other than base stations 20 (e.g., MME or S-GW may be envisaged, but not limited to MME or S-GW). As illustrated above, although only one network node is illustrated as the other network node other than the base station 20, other network nodes other than the base station 20 may be a combination of multiple other network nodes (e.g., MME and S-GW).

Each of the embodiments/embodiments described herein may be used alone, in combination, or switched upon implementation.

User equipment 10 may be referred to by one of ordinary skill in the art as a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable term.

Base station 20 may be referred to by one of ordinary skill in the art as NB (NodeB), eNB (enhanced NodeB), base station (Base Station), gNB, or some other suitable term.

As used herein, the term “determining” may encompass a wide variety of operations. “Determining” may be regarded as, for example, judging, calculating, computing, processing, deriving, investigating, looking up (e.g., looking up a table, database or other data structure), ascertaining, or the like. “Determining” may be regarded as, for example, receiving (e.g., receiving information), transmitting (e.g., transmitting information), inputting, outputting, accessing (e.g., accessing data in memory). “Determining” may be regarded as resolving, selecting, choosing, establishing, comparing, and the like. In other words, “determining” may include determining a certain action.

As used herein, the phrase “based on” does not mean “based solely on” unless otherwise specified. In other words, “based on” means both “based solely on” and “based at least on.”

As long as the terms “include,” “including,” and variants thereof are used herein or in the claims, these terms are intended to be comprehensive, as are the terms “comprising.” Furthermore, it is intended that the term “or” as used herein or in the claims is not an exclusive OR.

In the entirety of the present disclosure, if an article is added by translation, such as, for example, a, an, and the as used in English language, these articles may include a plurality of articles unless the context clearly indicates that they are not.

While the invention is described in detail, it will be apparent to those skilled in the art that the invention is not limited to the embodiments described herein. The invention can be implemented as modifications and alterations without departing from the gist and scope of the invention as defined by the appended claims. Accordingly, the description herein is intended for illustrative purposes and does not have any limiting meaning to the present invention.

### LIST OF REFERENCE SYMBOLS

10 User equipment
110 Transmission unit
120 Receiving unit
130 Control unit
140 Data storage unit
20 Relay base station
210 Transmission unit
220 Receiving unit
230 Control unit
240 Data storage unit
30 Donor base stations
1001 Processor
1002 Memory
1003 Storage
1004 Communication device
1005 Input device
1006 Output device

1. User equipment, comprising:
a transmission unit that transmits a random access preamble;
a reception unit that receives a plurality of random access responses; and
a control unit that selects which of the plurality of random access responses received by the reception unit is used to transmit data.

2. The user equipment of claim 1, wherein the control unit selects the random access response received most recently with respect to time among the plurality of random access responses received by the reception unit.

3. The user equipment of claim 1, wherein the control unit compares the timing advance value included in each random access response of the plurality of random access responses received by the reception unit to detect a minimum timing advance value and selects a random access response including the minimum timing advance value.

4. The user equipment of claim 1, wherein the control unit compares the scheduling information included in each random access response of the plurality of random access responses received by the reception unit to detect scheduling information including the earliest uplink transmission timing with respect to time and selects a random access response including scheduling information including the earliest uplink transmission timing.

5. The user equipment of claim 1, wherein the control unit compares the scheduling information included in each random access response of the plurality of random access responses received by the reception unit to detect scheduling information including allocation information of a resource having the smallest frequency-direction size, and selects a random access response including scheduling information including allocation information of a resource having the smallest frequency-direction size.

6. A communication method comprising:
a step of transmitting a random access preamble;
a step of receiving a plurality of random access responses; and
a step of selecting which of the plurality of random access responses received by the reception unit is used to transmit data.
